(19) United States
(12) Patent Application Publication
(10) Pub. No.: US 2014/0017155 A1
(43) Pub. Date: Jan. 16, 2014

(54) PROCESS FOR PREPARING TRICHLOROSILANE

(71) Applicants: Ekkehard Müh, Rheinfelden (DE); Hartwig Rauleder, Rheinfelden (DE); Bernd Nowitzki, Marl (DE)

(72) Inventors: Ekkehard Müh, Rheinfelden (DE); Hartwig Rauleder, Rheinfelden (DE); Bernd Nowitzki, Marl (DE)

(73) Assignee: Evonik Degussa GmbH, Essen (DE)

(21) Appl. No.: 13/884,326

(22) PCT Filed: Oct. 13, 2011
(86) PCT No.: PCT/EP2011/067847

§ 371 Date: Jul. 29, 2013

(30) Foreign Application Priority Data
Nov. 9, 2010 (DE) 102010043646.1

(51) Int. Cl. C01B 33/107

(52) U.S. Cl. CPC C01B 33/10763; C01B 33/10773
USPC 423/342

(57) ABSTRACT

The present invention relates to a process for preparing trichlorosilane and optionally, if required, HCDS and OCTS, by a) in a first step, allowing silicon tetrachloride and silicon to react at a temperature of >800 to 1450° C., b) in a step two, cooling the product stream (PS) thus obtained from step one to obtain a product stream (PG2), c) optionally, in a step three, removing STC and HCDS from the product stream (PG2) to obtain, as a residue or bottom product, a product mixture (PG3), d) optionally, in a step four, removing OCTS from the product stream PG3 from step three, to obtain, as a residue or bottom product, a product mixture (PG4), e) in a step five, reacting the product stream (PG2) originating from step two or the product mixture (PG3) originating from step three or the product mixture (PG4) originating from step four, or a mixture of product streams PG2 and PG3 or a mixture of product streams PG2 and PG4 with hydrogen chloride to obtain a product stream (PHS), and f) in a subsequent step six, removing trichlorosilane from a product stream (PHS) thus obtained, and discharging the remaining STC-containing bottoms or recycling them as a reactant component into step one of the process.

The present invention relates to a process for preparing trichlorosilane (TCS), wherein hexachlorodisilane (HCDS) and/or octachlorotrisilane (OCTS) can optionally be obtained in addition.

TCS is nowadays an important and increasingly sought-after starting compound in industrial silane chemistry. For example, it is possible by hydrosilylation of monounsaturated and optionally substituted olefins to prepare organochlorosilanes which can be converted to organoalkoxysilanes by a simple esterification with an alcohol. It is also possible by dismutation of TCS to obtain monosilane in very pure form, which in turn is processed further by thermal decomposition to polycrystalline silicon, especially for semiconductor applications. A by-product obtained in the dismutation of TCS and in Si production by the Siemens process is silicon tetrachloride (STC) which can be used, for example after esterification with an alcohol in the form of tetraalkoxysilane, for sol-gel technologies, in the production of precipitated silica, or, after a complex purification, as a feedstock for the production of glass fibre cable or else as a reactant component in the production of fumed silica. However, it is frequently the case that the amounts of STC streams obtained have to be recycled within an integrated system or set to another use.

TCS is produced industrially predominantly by the reaction of silicon (Si), for example metallurgical silicon, and hydrogen chloride (HCl) at relatively high temperature (DE 36 40 172 inter alia). Relatively large amounts of STC are also obtained.

In addition, TCS can be obtained by catalytic hydrogenation of STC (WO2005/102927, WO2005/102928 inter alia).

It has long been known that a reaction of Si and STC at 1250° C. and quenching of the product stream affords higher chlorosilanes (SiₙCl₂ₙ₊₂ where n=2 to 25 or 2 to ∞) [Hollemann-Wiberg, Lehrbuch der anorganischen Chemie [Inorganic Chemistry], 81st-90th ed., pages 539 and 540, (1976)], cf. also WO2009/143823, WO2009/143824.

As a result of recent developments, in the semiconductor industry among others, there is an increasing demand on the market for HCDS and OCTS.

It is likewise known that higher chlorosilanes can also be re-dissociated to obtain lower chlorosilanes. The dissociation can be effected thermally or catalytically (GB 575,669, inter alia).

It was an object of the present invention to provide a further process for preparing trichlorosilane, in which STC can be used as a reactant component. In addition, it was a particular desire, if possible, to provide a means by which not only TCS but additionally HCDS and/or OCTS can be derived from the process.

The stated object is achieved in accordance with the invention according to the details in the claims.

It has been found that, surprisingly, trichlorosilane (TCS) and optionally, if required, hexachlorodisilane (HCDS) and/or octachlorotrisilane (OCTS) can be prepared using silicon tetrachloride (STC) in an advantageous, simple and economically viable manner, by
a) in a first step, allowing silicon tetrachloride and silicon to react at a temperature of >800 to 1450° C., preferably 900 to 1350° C., more preferably 1000 to 1300° C., especially 1100 to 1250° C.,
b) in a step two, cooling the product stream (PS) thus obtained from step one to obtain a product stream (PG2),
c) optionally, in a step three, removing STC and HCDS from the product stream (PG2) to obtain, as a residue or bottom product, a product mixture (PG3),
d) optionally in a step four, removing OCTS from the product stream PG3 from step three, to obtain, as a residue or bottom product, a product mixture (PG4),
e) in a step five, reacting the product stream (PG2) originating from step two or the product mixture (PG3) originating from step three or the product mixture (PG4) originating from step four, or a mixture of product streams PG2 and PG3 or a mixture of product streams PG2 and PG4 with hydrogen chloride to obtain a product stream (PHS), and
f) in a subsequent step six, removing trichlorosilane from a product stream (PHS) thus obtained and discharging the remaining STC-containing bottoms or recycling them as a reactant component into step one of the process.

The present invention thus provides a process for preparing trichlorosilane and optionally HCDS and OCTS,

by
a) in a first step, allowing silicon tetrachloride and silicon to react at a temperature of >800 to 1450° C.,
b) in a step two, cooling the product stream (PS) thus obtained from step one to obtain a product stream (PG2),
c) optionally, in a step three, removing STC and HCDS from the product stream (PG2) to obtain, as a residue or bottom product, a product mixture (PG3),
d) optionally in a step four, removing OCTS from the product stream PG3 from step three, to obtain, as a residue or bottom product, a product mixture (PG4),
e) in a step five, reacting the product stream (PG2) originating from step two or the product mixture (PG3) originating from step three or the product mixture (PG4) originating from step four, or a mixture of product streams PG2 and PG3 or a mixture of product streams PG2 and PG4 with hydrogen chloride to obtain a product stream (PHS), and
f) in a subsequent step six, removing trichlorosilane from a product stream (PHS) thus obtained and discharging the remaining STC-containing bottoms or recycling them as a reactant component into step one of the process.

In the process according to the invention, it is advantageous to use reactors which generally consist of a high-alloy steel, preferably from the group of the Ni steels, especially those which, in addition to Ni, also contain Cr and/or Mo and Ti. In addition, in the present invention, preference is given to using reactors with a capacity of 10 cm³ to 20 m³ coupled with a diameter of 1 cm to 2 m and a height of 10 cm to 10 m. The supply of silicon to the reactor may be in portions, i.e. batchwise, or continuous.

In the process according to the invention, in step one, it is advantageous to use a silicon quality with an Si content of at least 50% by weight of Si, preferably 60 to 100% by weight, more preferably 80 to 99% by weight, especially 90, 91, 92, 93, 94, 95, 96, 97, 98% by weight. Preference is given to silicon qualities from the group of metallurgical silicon, ferrosilicon, pure or high-purity silicon, which may suitably be in piece or lump form ranging up to fine pulverulent form, preferably those with a particle size of <30 cm, more preferably 1 μm to 20 cm, for example—but not exclusively—from a carbothermal or aluminothermal preparation process for silica or even from a thermal monosilane or chlorosilane decomposition or sowing residues from semiconductor or chip production. It is also possible to adjust the silicon to a desired particle size by grinding before introduction into the reactor. In addition, the silicon before introduction into the reactor is suitably purged by means of inert gas, for example nitrogen or argon, to essentially free it of water and oxygen.

The metered addition of STC into the reactor is preferably continuous, in which case the STC can be conducted into the reactor cold, i.e. in liquid form, or preheated, i.e. in liquid or gaseous form. To preheat the STC stream, it is advantageously possible to utilize waste heat which arises in the process. In the reactor, the STC can be passed over the heated silicon or preferably passed through a heated arrangement of silicon, for example fixed beds or fluidized beds; for example it is possible for STC to flow from below through a heated and silicon-charged reactor.

The reactor can be heated, for example, electrically or indirectly by means of gas burners, for example using a heat exchanger system.

Step one of the process according to the invention is advantageously performed in a fixed bed reactor or in a fluidized bed reactor at a pressure of 0.1 to 10 bar, preferably 0.2-1.5, more preferably 0.3-1.2, even more preferably 0.4-0.9, and especially 0.5-0.7 bar, and essentially with exclusion of oxygen and water.

This conversion of STC and Si in step one can be performed in the presence of a catalyst, said catalyst preferably being selected from the group of at least one element or at least one compound of an element of the transition metals or main groups one to five of the Periodic Table of the Elements, preferably selected from Fe, Co, Ni, Cr, Mo, W, Ti, Zr, Zn, Cd, Cu, Na, K, Mg, Ca, B, Al, C, Ge, Sn, Pb, P, As, Sb, for example but not exclusively in elemental form, as an alloy, as chlorides, as silicides, to mention just a few options. For this purpose, the catalyst can be added to the silicon in the course of preparation thereof and/or when the reactor is charged.

In step two of the process according to the invention, the product stream (PS) from step one is cooled using a heat exchanger and/or quenched by feeding in liquid STC, the resulting product stream (PG2) preferably having a temperature above 50° C., preferably above 220° C., leaving STC or HCDS and OCTS advantageously in the gas phase, it being possible to fractionally separate the HCDS and OCTS after the removal of the condensate. Suitably, PG2 is still under pressure, in order to avoid or to minimize any loss of heat/energy in the condensate if possible.

Optionally, in a step three, STC and HCDS can be removed from the product stream (PG2) by a fractional distillation, so as to obtain HCDS as an additional value-adding product, STC can be recycled into step one and/or two and the residue or the bottom product (PG3) can optionally be supplied to step four or to step five.

As a further option for an additional increase in the addition of value to the process according to the invention it is advantageously possible, in a step four, to remove further value-adding OCTS product from the residue (PG3) from step three by a fractional distillation, and to supply the remaining residue or the bottom product (PG4) to step five.

In addition, in the process according to the invention, the reaction in step five is performed preferably at a temperature of 20 to 200° C., more preferably of 50 to 150° C., especially of 80 to 120° C. and a pressure preferably of 10 mbar to 10 bar, more preferably of 100 mbar to 2 bar, especially of 800 mbar to 1.2 bar, using HCl, generally in gaseous form, in excess. Moreover, this conversion or reaction can optionally be performed in the presence of a catalyst.

For instance, the nitrogen-containing catalyst used here with preference in the process according to the invention may be an amino-functionalized catalyst functionalized with organic radicals, especially an aminoalkyl-functionalized catalyst, which is preferably additionally polymeric and is chemically fixed to a support material. Alternatively it is also possible to use solid insoluble and/or relatively high-boiling nitrogen-containing compounds as the catalyst. Useful support materials generally include all materials which possess reactive groups to which the amino-functionalized catalysts can be bonded. The support material is preferably in the form of a shaped body, such as in the form of balls, rods or particles.

Particularly preferred nitrogen containing catalysts are the following catalysts and/or nitrogen-containing catalysts derived therefrom by hydrolysis and/or condensation, such as
an amino-functionalized compound with alkyl-functionalized secondary, tertiary and/or quaternary amino groups, especially an aminoalkoxysilane of the general formula V or more preferably at least one hydrolysis and/or condensation product thereof

(C_{z}H_{2z+1}O)₃Si(CH₂)_{d}N(C_{g}H_{2g+1})₂ (V)
where z=1 to 4, g=1 to 10, d=1 to 3 or a monomeric or oligomeric aminosilane derived therefrom and chemically bonded to a support material; more preferably in formula V, independently z=1 to 4, especially 1 or 2, d=3 or 2 and g=1 to 18, or a hydrocarbyl-substituted amine of the formula VI or VII

NHₖR₃₋ₖ (VI)
where k=0, 1 or 2, where R groups are the same or different and R is an aliphatic linear or branched or cycloaliphatic or aromatic hydrocarbon having 1 to 20 carbon atoms, R preferably having at least 2 carbon atoms, or

[NHₗR¹₄₋ₗ]⁺Z⁻ (VII)
where l=0, 1, 2 or 3, where R¹ groups are the same or different and R¹ is an aliphatic linear or branched or cycloaliphatic or aromatic hydrocarbon having 1 to 18 carbon atoms, R¹ preferably having at least 2 carbon atoms and Z is an anion, preferably a halide, or
a divinylbenzene-crosslinked polystyrene resin with tertiary amine groups.

Particular preference is given to a catalyst based on at least one aminoalkoxysilane of the general formula V or a catalyst obtained by hydrolysis and/or condensation, which is preferably fixed chemically to a support, preferably bonded covalently to the support, especially to a silicatic support. More preferably in accordance with the invention, the catalyst is diisobutylaminopropyltrimethoxysilane or a hydrolysis and/or condensation product thereof and is advantageously used on a silicatic support material, for example but not exclusively supports based on a precipitated or fumed silica. Suitably, all catalysts used in the process according to the invention are anhydrous or essentially anhydrous. Therefore, said catalysts are advantageously dried and essentially freed of water before they are used in the present process.

In step six of the process according to the invention, after the removal of TCS, which is preferably effected by a fractional distillation, the essentially STC-containing residue or bottom product can be recycled into the process, especially into step one and/or two.

In general, the process according to the invention can be performed as follows:

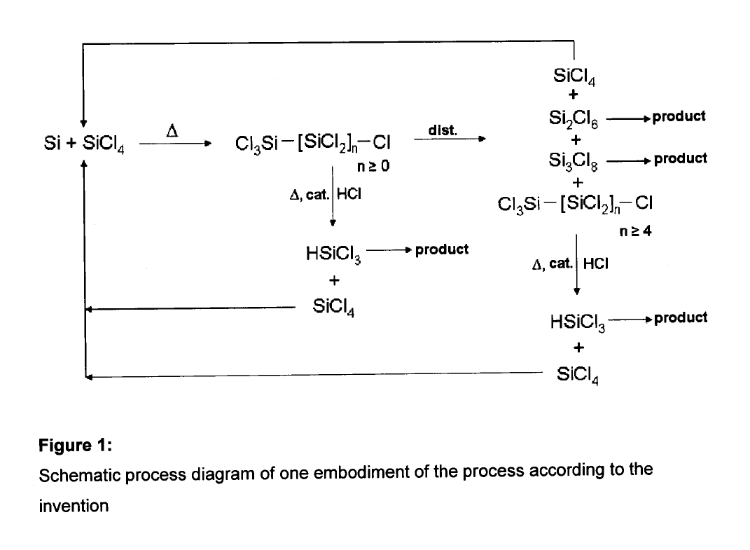

FIG. 1 is a schematic representation of a preferred process diagram of the present invention.

In general, a reactor is charged with silicon, purged with an inert gas, for example nitrogen, and heated, and silicon tetrachloride (STC) is then added, it being possible to supply STC to the reactor in liquid or gaseous form. The stream of inert gas can be recycled at the same time. According to the conversion, it is possible to meter further silicon into the reactor, in portions or continuously. For instance, STC, especially STC return streams obtained from chlorosilane processes, it being possible for such streams in some cases also to contain high boilers, can be thermally reacted with silicon, for example metallurgical Si and/or Si wastes from solar/semiconductor silicon production. The halogenated polysilanes which form are subsequently removed from the reaction zone or condensed out, for example by quenching with SiCl₄. The mixture of halogenated polysilanes thus obtained can be converted by means of HCl in the presence of a catalyst to trichlorosilane and SiCl₄, and TCS can be removed. TCS can advantageously be used again for the preparation of monosilane, silicon, especially for semiconductor applications, or functional silanes. The remaining SiCl₄ can advantageously be recycled back into the inventive process for the reaction with Si. Optionally, it is possible in the process according to the invention first to remove unreacted SiCl₄ and the hexachlorodisilane and/or octachlorotrisilane products by fractional distillation or condensation from the mixture of halogenated polysilanes obtained after conversion of Si and STC. SiCl₄ obtained is recycled into the reaction with Si. Hexachlorodisilane and octachlorotrisilane thus obtained are products used in the semiconductor industry; these too can serve as a raw material for the preparation of hydrogenated polysilanes. The distillation bottoms generally consist of more highly halogenated polysilanes with a degree of oligomerization greater than or equal to 4, and are then cleaved to trichlorosilane and SiCl₄ with addition of HCl in the presence of a catalyst, preferably a nitrogen-containing catalyst, more preferably an amino-functionalized catalyst functionalized with organic radicals, especially an aminoalkyl-functionalized catalyst, which is preferably additionally in polymeric form, and is chemically fixed to a support material, especially silica-supported diisobutylaminopropyltrimethoxysilane, and separated, for example by fractional distillation. TCS obtained in this way can advantageously be used for the preparation of monosilane, polycrystalline silicon or functional silanes. SiCl₄ remaining is advantageously recycled back into the reaction with Si of the process according to the invention.

In the process according to the invention, it is, however, also possible to subject the mixture of halogenated polysilanes obtained from the conversion of Si and STC at least partly to the optional process step(s) detailed above.

Thus, the process according to the invention enables, in an advantageous and economically viable manner, conversion of STC obtained in various chemical processes back to TCS and, furthermore, HCDS and/or OCTS to be obtained if required.

The present invention is illustrated in detail by the examples which follow, without restricting the subject matter of the invention.

### EXAMPLES

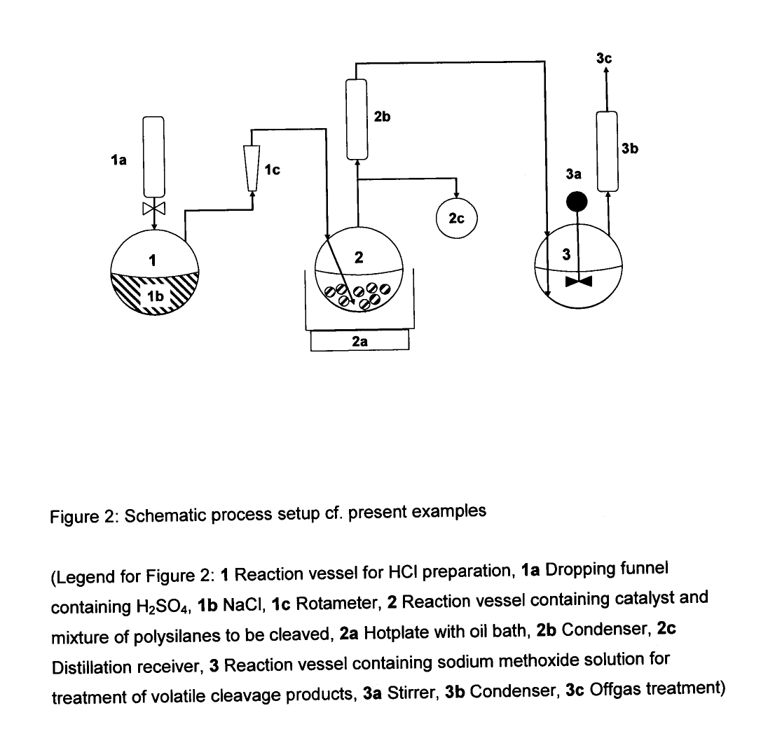

FIG. 2 shows the schematic experimental setup of the experiments conducted here.

1. Reaction of SiCl₄ with Metallic Silicon

SiCl₄ vapour was passed at a pressure of approx. 50 mbar over silicon pieces (metallurgical silicon, Si content >98%, diameter approx. 5 mm) in a silicon carbide tube. The reaction tube was heated electrically to 1150° C. and the gases escaping from the reaction zone were cooled rapidly using a water-cooled cooling zone. The condensation was effected in a first stage with brine cooling (−25° C.). Small amounts of SiCl₄ were condensed with liquid nitrogen in a second stage to protect the vacuum pump. The condensate obtained in the first condensation stage was removed continuously. The composition of the condensate obtained was analyzed by means of GC.

### GC Analysis of the Resulting Condensate:

| | GC sample | | | | |
|---|---|---|---|---|---|
| | | | | | Higher |
| | SiCl₄ | Si₂Cl₆ | Si₃Cl₈ | Si₄Cl₁₀ | oligom. |
| | (TCD %) | (TCD %) | (TCD %) | (TCD %) | (TCD %) |
| Reaction | 41.3 | 12.8 | 29.7 | 10.1 | 6.1 |
| mixture | | | | | |

### 2. Distillative Removal of Silicon Tetrachloride

1070 g of the chlorosilane mixture obtainable according to Example 1 was partially distilled to remove the low boiler fraction (SiCl₄).

For this purpose, the chlorosilane mixture was distilled in a distallation apparatus with a 115 cm column (Sulzer LAB-EX metal packing) and jacketed coil condenser at a bottom temperature of 80° C. and a reduced pressure of 350 mbar until no further SiCl₄ distilled over (top temperature approx. 26° C.).

Distillate mass: 452.6 g

Bottoms mass: 615.4 g

### GC Analyses:

| | GC sample | | | | |
|---|---|---|---|---|---|
| | | | | | Higher |
| | SiCl₄ | Si₂Cl₆ | Si₃Cl₈ | Si₄Cl₁₀ | oligom. |
| | (TCD %) | (TCD %) | (TCD %) | (TCD %) | (TCD %) |
| Starting | 41.3 | 12.8 | 29.7 | 10.1 | 6.1 |
| sample | | | | | |
| Bottoms | — | 21.7 | 50.5 | 17.2 | 10.4 |
| Distillate | 99.7 | 0.2 | — | — | — |

### 3. Distillative Removal of Hexachlorodisilane and Octachlorotrisilane

The chlorosilane mixture obtained in the distillation bottoms according to Example 2 was distilled further in the above-described distillation apparatus to remove Si₂Cl₆. At a bottom temperature of approx. 105° C. and a pressure of 11 mbar, Si₂Cl₆ distilled over at a top temperature of 35 to 42° C. At a bottom temperature of approx. 108° C. and a pressure of <1 mbar, Si₃Cl₈ distilled at a top temperature of 51 to 57° C.

Masses: Fraction 1: 82.2 g; fraction 2: 330.1 g; bottoms 195.7 g

### GC Analyses:

| | GC sample | | | | |
|---|---|---|---|---|---|
| | SiCl₄ | Si₂Cl₆ | Si₃Cl₈ | Si₄Cl₁₀ | Higher |
| | (TCD %) | (TCD %) | (TCD %) | (TCD %) | oligom. |
| Starting | — | 21.7 | 50.5 | 17.2 | 10.4 |
| sample | | | | | |
| Fraction 1 | — | 99.7 | — | — | — |
| Fraction 2 | — | 11.9 | 86.1 | 0.5 | — |
| Bottoms | — | 3.8 | 10.4 | 61.0 | 24.3 |

### 4. Cleavage of the Chlorosilane Mixture

### Idealized Reaction Equations:

$${Si}_{3} {CI}_{8} + HCI {}^{cat .} {Si}_{2} {CI}_{6} + {HSiCI}_{3}$$

$${Si}_{2} {CI}_{6} + HCI {}^{cat .} {SiCI}_{4} + {HSiCI}_{3}$$

### Procedure:

135 g of NaCl for the HCl preparation were initially charged in a 11 three-neck flask with dropping funnel and gas outlet (reaction vessel 1) and 270 ml conc. H₂SO₄ were introduced into the dropping funnel. A 2 l three-neck flask with stirrer, gas inlet tube and reflux condenser (reaction vessel 3) was initially charged with sodium methoxide solution (30%) with added indicator (phenolphthalein). This flask was ice-cooled over the course of the entire reaction.

A 250 ml four-neck flask with gas inlet tube, thermometer, gas outlet and column top with distillate receiver was initially charged with 24 g of the catalyst spheres described below and 72.5 g of a mixture principally containing octachlorotrisilane (for composition see GC Table, SiCl₄ had already been distilled out of the chlorosilane mixture obtained after Example 1 according to Example 2 and the majority of the Si₂Cl₆ according to Example 3) were added.

The reaction flask (2) was heated to 90° C. by means of an oil bath and the sulphuric acid was added dropwise to the sodium chloride. The rate of dropwise addition was adjusted so as to give a constant HCl flow of approx. 3 l/h over the entire duration of the experiment. The gaseous hydrogen chloride was bubbled through the catalyst spheres by means of a gas inlet tube in the lower part of the flask. The gas stream was introduced into the cooled sodium methoxide solution via the reflux condenser for neutralization.

After a reaction time of 20 min, reflux set in in the reaction flask and liquid was collected in the distillation receiver.

After a reaction time of 2 h, the experiment was stopped. 6.8 g of distillate had collected in the receiver.

GC analyses of the distillate in the receiver, of the liquid remaining in the reaction flask (bottoms) and of the starting material, were conducted.

### GC Analysis:

| | GC sample | | | | |
|---|---|---|---|---|---|
| | | | | | Si₄Cl₁₀ |
| | | | | | and higher |
| | HSiCl₃ | SiCl₄ | Si₂Cl₆ | Si₃Cl₈ | oligomers |
| | (TCD %) | (TCD %) | (TCD %) | (TCD %) | (TCD %) |
| Starting | — | — | 4.5 | 86.5 | 6.4 |
| sample | | | | | |
| Bottoms | 10.9 | 24.8 | 63.4 | — | — |
| Distillate | 35.1 | 64.9 | — | — | — |

Octachlorotrisilane can be cleaved in the presence of a suitable catalyst with HCl to give trichlorosilane and silicon tetrachloride. The reaction proceeds via hexachlorodisilane as a stable intermediate.

### 5. Cleavage of Distillation Bottoms According to Example 3

### Idealized Reaction Equations:

$${Si}_{4} {CI}_{10} + HCI {}^{cat .} {Si}_{3} {CI}_{8} + {HSiCI}_{3}$$

$${Si}_{3} {CI}_{8} + HCI {}^{cat .} {Si}_{2} {CI}_{6} + {HSiCI}_{3}$$

$${Si}_{2} {CI}_{6} + HCI {}^{cat .} {SiCI}_{4} + {HSiCI}_{3}$$

### Procedure:

210 g of NaCl for the HCl preparation were initially charged in a 11 three-neck flask with dropping funnel and gas outlet (reaction vessel 1) and 420 ml of conc. H₂SO₄ were introduced into the dropping funnel. A 2 l three-neck flask with stirrer, gas inlet tube and reflux condenser (reaction vessel 3) was initially charged with sodium methoxide solution (30%) with added indicator (phenolphthalein). This flask was ice-cooled over the entire reaction.

A 250 ml four-neck flask with gas inlet tube, thermometer, septum, gas outlet and column top with distillate receiver was initially charged with 24 g of the catalyst spheres described below, and 96.6 g of a mixture containing principally decachlorotetrasilane and higher oligomers (for composition see GC Table; SiCl₄, Si₂Cl₆ and Si₃Cl₈ were already distilled out of the chlorosilane mixture obtained after Example 1 according to Examples 2 and 3).

The reaction flask (2) was first heated to 85° C., and after 1 h to 95° C. by means of an oil bath and the sulphuric acid was added dropwise to the sodium chloride. The rate of dropwise addition was adjusted so as to give a constant HCl flow of approx. 2.5 l/h over the entire duration of the experiment. The gaseous hydrogen chloride was bubbled through the catalyst spheres by means of a gas inlet tube in the lower part of the flask. The gas stream was introduced into the cooled sodium methoxide solution via the reflux condenser for neutralization.

After a reaction time of 2 h, very weak reflux set in in the reaction flask. From approx. 3 h, liquid distilled over gradually and was collected in the distillation receiver.

After a reaction time of 4 h, the experiment was stopped. 6.0 g of distillate had collected in the receiver.

After a reaction time of 1 h, 2 h and 4 h, samples were taken from the reaction flask via the septum (bottoms 1-3). GC analyses of the distillate in the receiver, the samples from the reaction flask and the starting material were conducted.

### GC Analysis:

| | HSiCl₃ | SiCl₄ | Si₂Cl₆ | Si₃Cl₈ | Si₄Cl₁₀ | Higher |
|---|---|---|---|---|---|---|
| GC sample | (TCD %) | (TCD %) | (TCD %) | (TCD %) | (TCD %) | oligomers |
| Starting | — | — | 0.5 | 3.2 | 81.7 | 12.2 |
| sample | | | | | | |
| Bottoms 1* | 2.7 | 3.5 | 14.8 | 12.0 | 53.8 | 8.5 |
| Bottoms 2* | 2.3 | 4.6 | 33.0 | 16.7 | 30.4 | 7.4 |
| Bottoms 3* | 4.5 | 9.5 | 46.5 | 9.4 | 15.9 | 5.6 |
| Distillate** | 22.9 | 62.5 | 14.1 | — | — | — |

*In the case of bottoms samples 1-3 trace signals occurred between the main signals and originate from partially hydrogenated chlorosilane oligomer species which were likewise formed during the degradation reaction. This explains the deviations from 100%.
**Hexachlorodisilane was partly collected in the receiver due to the long, continuous stripping with HCl in spite of a much higher boiling temperature.

Decachlorotetratrisilane can be cleaved in the presence of a suitable catalyst with HCl to give trichlorosilane and silicon tetrachloride. The reaction proceeds via octachlorotrisilane and hexachlorodisilane as the most stable intermediates.

### 6. Preparation of the Supported Catalyst:

600 g of hydrous ethanol (H₂O content=5%) and 54 g of 3-diisobutylaminopropyl-trimethoxysilane were initially charged with 300 g of catalyst support (SiO₂ spheres, Ø approx. 5 mm). The reaction mixture was heated at an oil bath temperature of 123 to 128° C. for 5 hours. After cooling, the supernatant liquid was filtered off with suction and the spheres washed with 600 g of anhydrous ethanol. After one hour, the liquid was filtered off with suction again. The spheres were pre-dried at a pressure of 305 to 35 mbar and a bath temperature of 110 to 119° C. for one hour and then dried at <1 mbar for 9.5 hours.

1. A process for preparing trichlorosilane, the process comprising:
reacting silicon tetrachloride and silicon at a temperature of >800 to 1450° C., to obtain a product stream (PS),
cooling the product stream (PS) obtain a product stream (PG2),
optionally removing silicon tetrachloride and hexachlorodisilane from the product stream (PG2) to obtain, as a residue or bottom product, a product mixture (PG3),
optionally removing octachlorotrisilane from the product mixture (PG3) to obtain, as a residue or bottom product, a product mixture (PG4),
reacting the product stream (PG2), the product mixture (PG3), the product mixture (PG4), a mixture of product stream (PG2) and product mixture (PG3), or a mixture of product stream (PG2) and product mixture (PG4) with hydrogen chloride to obtain a product stream (PHS), and
removing trichlorosilane from the product stream (PHS) and discharging remaining bottoms comprising silicon tetrachloride or recycling the bottoms as a reactant component into the reacting of silicon tetrachloride and silicon.

2. The process according to claim 1,
wherein the reacting of silicon tetrachloride and silicon
is performed in a fixed bed reactor or in a fluidized bed reactor at a pressure of from 0.1 to 10 bar and essentially with exclusion of oxygen and water.

3. The process according to claim 1,
wherein
the product stream (PS) from the reacting of silicon tetrachloride and silicon is conducted with a flow rate of from 0.1 cm/s to 1 m/s.

4. The process according to claim 1,
wherein
the reacting of the silicon tetrachloride and silicon is performed in the presence of a catalyst, and the catalyst is at least one selected from the group consisting of an element, and a compound of an element of transition metals or main groups one to five of the Periodic Table of the Elements.

5. The process according to claim 1,
wherein
the reacting of silicon tetrachloride and silicon is charged continuously or batchwise with a silicon quality with a Si content of at least 50% by weight of Si.

6. The process according to claim 1,
wherein the cooling comprises:
cooling the product stream (PS) from the reacting of silicon tetrachloride and silicon with a heat exchanger, quenching by feeding in liquid silicon tetrachloride, or both.

7. The process according to claim 1,
wherein the removing of the silicon tetrachloride and hexachlorodisilane comprises removing
by a fractional distillation, and recycling the silicon tetrachloride into the reacting of silicon tetrachloride and the silicon, into the cooling, or both, and optionally supplying the reside or the bottom product (PG3) to the removing of octachlorotrisilane or the reacting of the product stream (PG2).

8. The process according to claim 1,
wherein the removing of octachlorotrisilane comprises removing octachlorotrisilane from the residue (PG3) by a fractional distillation and supplying a remaining residue or the bottom product (PG4) to the reacting of the product stream (PG2).

9. The process according to claim 1,
wherein
the reacting of the product stream (PG2) comprises reacting at a temperature of from 20° C. to 200° C. at a pressure of from 10 mbar to 10 bar, with HCl in excess and in the presence of a catalyst.

10. The process according to claim 9,
wherein
the reacting of the product stream (PG2) is performed in the presence of diisobutylaminopropyltrimethoxysilane supported on silica.

11. The process according to claim 1,
wherein after the removing of trichlorosilane,
the residue or bottom product comprising silicon tetrachloride is recycled into the reacting of silicon tetrachloride and silicon.

12. The process according to claim 1, wherein the process comprises removing silicon tetrachloride and hexachlorodisilane from the product stream (PG2) to obtain, as a residue or bottom product, a product mixture (PG3).

13. The process according to claim 1, wherein the process comprises removing octachlorotrisilane from the product mixture (PG3) to obtain, as a residue or bottom product, a product mixture (PG4).

14. The process according to claim 6, wherein the resulting product stream (PG2) has a temperature above 50° C.

15. The process according to claim 6, wherein the resulting product stream (PG2) has a temperature above 220° C.

16. The process according to claim 7, wherein the residue or bottom product (PG3) is supplied to the removing of octachlorotrisilane or the reacting of the product stream (PG2).

17. The process according to claim 9, wherein the reacting of the product stream (PG2) comprises reacting in the presence of a catalyst.

18. The process according to claim 1, wherein the reacting of silicon tetrachloride and silicon is at a temperature of from 900 to 1350° C.

19. The process according to claim 1, wherein the reacting of silicon tetrachloride and silicon is at a temperature of from 1000 to 1300° C.

20. The process according to claim 1, wherein the reacting of silicon tetrachloride and silicon is at a temperature of from 1100 to 1250° C.
